(19) United States
(12) Patent Application Publication
(10) Pub. No.: US 2021/0347114 A1
(43) Pub. Date: Nov. 11, 2021

(54) REINFORCEMENT ELEMENT AND PROCESS FOR MANUFACTURING A FUNCTIONAL HYBRID REINFORCEMENT ELEMENT

(71) Applicant: RHENOFLEX GMBH, Ludwigshafen (DE)

(72) Inventors: Frank Boettcher, Haan (DE); Henritte Jaerger, Heuchelheim bei Frankenthal (DE)

(73) Assignee: RHENOFLEX GMBH, Ludwigshafen (DE)

(21) Appl. No.: 17/272,724

(22) PCT Filed: Oct. 17, 2019
(86) PCT No.: PCT/EP2019/078288

§ 371 Date: Mar. 2, 2021

(30) Foreign Application Priority Data
Oct. 23, 2018 (DE) 10 2018 218 115.2

(51) Int. Cl. B29C 64/165; A43B 23/08; B33Y 80/00; B33Y 10/00

(52) U.S. Cl. CPC B29C 64/165; A43B 23/087; B29L 2031/50; B33Y 10/00; B33Y 80/00

(57) ABSTRACT

A reinforcing element, suited in particular for shoes, bags or orthopedic applications, comprises a support layer, and a reinforcing layer. The support layer is formed such that it protrudes at least in parts laterally beyond the reinforcing layer to form an edge region. A method for producing such a reinforcing element.

### BACKGROUND

### 1. Field of the Disclosure

The disclosure relates to a reinforcing element suited in particular for shoes, bags, orthopedic applications or the like. The disclosure further relates to a method for producing such a reinforcing element.

### 2. Discussion of the Background Art

Such reinforcing elements may be produced of e.g., a powdery material. Here, the powder is given in particular its desired final shape already, using a slider or a template. The powder is compounded by applying pressure and/or heat, so that a corresponding reinforcing element is obtained. Such a method is described in particular in EP 0 222 220 B1, as well as WO 1012/059367.

In particular for reinforcing elements for shoes, specifically in the form of a front cap at the toes or a rear cap in the region of the heels, it is desired that such reinforcing elements have different rigid regions.

It is an object of the disclosure to provide a reinforcing element, as well as a method for producing a reinforcing element having regions of different rigidity.

### SUMMARY

The reinforcing element of the disclosure is suited in particular for shoes, bags, orthopedic applications and the like. For shoes, the use of reinforcing elements made from different materials is known. For example, a reinforcement of the shoes in the region of the heel is effected by means of a rear cap or similarly by means of a front cap in the region of the toes. Likewise, with shoes, reinforcing elements are known in the region of the eyelets for the shoestrings to avoid tearing. With bags, such as handbags, sports bags or the like, such reinforcing elements are also provided in bags made of flexible material, e.g., in corners in the region of a strap fastening, bag bottoms and the like.

The reinforcing element of the present disclosure comprises a support layer, as well as a reinforcing layer. The reinforcing layer is connected with the support layer. The connection may be effected by providing an adhesive, wherein it is preferred that the material of the support layer and the reinforcing layer become connected by the application of pressure and/or heat. Therefore, the materials of the support layer and the reinforcing layer are preferably such that an in particular thermal bonding is possible, so that an additional provision of an adhesive is not required. In particular, the support layer and the reinforcing layer are made of the same or a chemically similar material.

According to the disclosure the support layer is configured such that an edge portion is formed that protrudes at least in part laterally beyond the reinforcing layer. A reinforcing element is formed thereby which has a greater rigidity in that region in which the support layer and the reinforcing layer lie one upon the other, than in that region in which only the support layer is provided. Due to the use of different materials, material densities and the like, it is further possible to vary the rigidity of the two layers. If so desired, a third layer or further layers could also be provided to create a further zone of different rigidity. Moreover, it would be possible to provide a plurality of reinforcing layers that are connected with the support layer in different regions. Here, the different reinforcing layers could be arranged at a distance from each other, cover each other in part or completely, or contact each other in edge regions.

It is particularly preferred that the edge portion formed by the support layer surrounds the reinforcing layer completely. Thereby, a circumferential edge region of lesser rigidity is created. Furthermore, it is preferred that the edge region has a substantially constant width, the width varying by ±20%, in particular by ±10%.

The support layer and/or the reinforcing layer may be made of rolled and/or plate material. For example, first a rolled material is produced from which corresponding plates are then cut. In this regard, suitable materials are e.g., impregnated materials which may in particular be impregnated with latex dispersions and may possibly be provided with an adhesive layer on one or both sides. A production by extrusion of thermoplastic materials is also suitable, which materials may possibly include a filler such as wood powder, recycled material or the like. When the support layer and/or the reinforcing layer are produced from such plate material, the corresponding shaped parts for forming the reinforcing element are e.g., punched or cut out. If the support layer and the reinforcing layer are made of plate material, they may then be glued to each other or, in particular, be connected by application of heat and pressure.

In a particularly preferred embodiment of the reinforcing element of the present disclosure the support layer and/or the reinforcing layer are made of a powder. Thereby, it is possible e.g., to arrange, using a slider and a template, a powder already in the desired final shape of the support layer and/or the reinforcing layer, and to compound it by the application of pressure and/or heat. The manufacture of the support layer and/or the reinforcing layer using powder is advantageous in particular in that the process step of punching or cutting out the support layer and/or the reinforcing layer from plate-shaped material is omitted. Further, a manufacture from powder has the advantage that no waste is produced. In a particularly preferred embodiment, it is possible to shred elements produced with faults, in particular to grind them and reuse the material. In particular powdery thermoplastic material is suited as a corresponding material. The same may be produced e.g., by grinding granulate. A preferred powder size is in the range from 50 μm to 900 μm, preferably 50 μm to 600 μm. A suitable production method is described in particular in EP 0 222 2213 B1, as well as WO 2012/059367.

The plastic material may possibly include a filler, such as e.g., polycarbonate, PET or other fillers.

Of course, a reinforcing layer and/or a support layer made from granulate by an extrusion method or from powder by the method described above can be given the final shape by cutting or punching. If need be, a slight finishing, such as cleaning the edges, may be useful.

Likewise, combinations of different support layers and reinforcing layers are also possible, so that e.g., the support layer is made from a granulate or powder and is then connected to a reinforcing layer of plate material.

It is further possible to produce the support layer and/or the reinforcing layer using a 3D printing method. In this regard, the FDN method as well as the SLS method are particularly suitable. Again, combinations of differently produced support layers and reinforcing layers are possible. Here, in particular both layers can be produced using the same above-mentioned method, while it is also possible to manufacture the two layers by different methods and, after having placed a memory element between the two layers, to connect them after and/or during the manufacturing process. It is particularly preferred that a reinforcing layer is printed by a 3D printing method directly on a support layer made e.g., of powder.

The reinforcing layer does not necessarily have a surface structure, but may e.g., also have a grid structure.

In a preferred development of the reinforcing element of the present disclosure, an adhesive film is provided on an outer side of the support layer and/or the reinforcing layer. The outer side is that side of the support layer and/or the reinforcing layer that is positioned on the outer side after the two inner sides of the support layer and/or the reinforcing layer have been connected. Providing an adhesive film on at least one of the two outer sides has the advantage that a good bonding of the reinforcing element to a cover material or another material layer is possible thereby. This may e.g., be the material of the shoe or the bag, e.g., a layer of leather, a textile fabric layer or the like.

Instead of providing an adhesive film it is also possible, depending on the material used, to realize bonding by thermal activation of the outer side of the support layer and/or the reinforcing layer.

The method of the disclosure for producing a reinforcing element is suited in particular for producing the above described reinforcing element. Especially in the method of the disclosure it is possible produce in particular reinforcing elements for shoes, bags, orthopedic applications and the like. According to the disclosure a reinforcing layer is connected to a support layer. These are, as described above with respect to the reinforcing element, made from corresponding materials. Further, the reinforcing layer and/or the support layer preferably are layers made of a plate material or directly from powder.

According to the disclosure, the support layer and the reinforcing layer are manufactured such that an edge region is formed. The edge region is formed such that the support layer protrudes at least in part laterally beyond the reinforcing layer. Corresponding to the above described preferred embodiment of the reinforcing element it is preferred that the production is performed such that the edge region surrounds the reinforcing region completely. Further, it is possible that the edge region has a substantially constant width, wherein the width varies preferably by less than ±20%, in particular by less than ±10%.

According to the method of the disclosure as well, one or a plurality of additional layers may be provided. Further, a plurality of reinforcing layers may be provided which are e.g., arranged at a distance from each other, cover each other and/or contact each other at their edges.

The reinforcing element can be produced such that a large-surface, in particular roll-shaped support layer is provided. Thereafter, a reinforcing layer is placed on parts of this support layer. By connecting the two layers a roll-shaped material is obtained, having reinforcing layers arranged at predetermined positions. Subsequent thereto, reinforcing elements can be punched out, so that reinforcing elements according to the disclosure are formed in which the support layer is formed such that it protrudes at least in part laterally beyond the reinforcing layer to form an edge region. The punching, cutting out or the like of the reinforcing elements can be effected immediately after the production of the raw material, so that the corresponding reinforcing elements are delivered to a customer that uses them e.g., to manufacture shoes, bags or orthopedic applications or the like. Further, the punching or cutting out of the reinforcing elements can be performed by the customer himself, so that rolled material is shipped to the customer. It is further possible to cut the rolled material such that plate-shaped material is obtained. The plates may then be shipped to a customer who will produce the corresponding reinforcing elements from the plate-shaped material, e.g., by punching or cutting.

In a particularly preferred use of powder particles, the reinforcing element is preferably produced such that the powder particles are arranged in one layer at least substantially in a final shape of an outer contour of the support layer and/or the reinforcing layer. Thereafter, a separate production of the support layer and the reinforcing layer can be performed by application of temperature and/or pressure. Two separate elements, i.e., the support layer and the reinforcing layer, are thus obtained. In the next step they can be joined by their inner sides. In particular when the support layer and the reinforcing layer are made from the same material, it is possible in a simple manner to join them using temperature and/or pressure so that the provision of adhesive material is not required.

It is particularly preferred to arrange powder for a support layer, but to not yet compound the powder particles. Thereafter, the powder for the reinforcing layer is applied. Subsequently, the powder is compounded by applying temperature and/or pressure. Thereby, a reinforcing element is created which, in particular, is made from a single material.

The disclosure will be described hereafter in more detail with reference to preferred embodiments and the accompanying drawings.

### BRIEF DESCRIPTION OF THE DRAWINGS

In the Figures:

FIG. 1 is a schematic view of a first embodiment for producing a reinforcing element of the present disclosure,

FIG. 2 is a schematic view of a second embodiment for producing a reinforcing element of the present disclosure,

FIG. 3 is a schematic view of a third embodiment for producing a reinforcing element of the present disclosure.

FIG. 4 is a schematic view of a fourth embodiment for producing a reinforcing element of the present disclosure.

### DETAILED DESCRIPTION OF THE PREFERRED EMBODIMENT

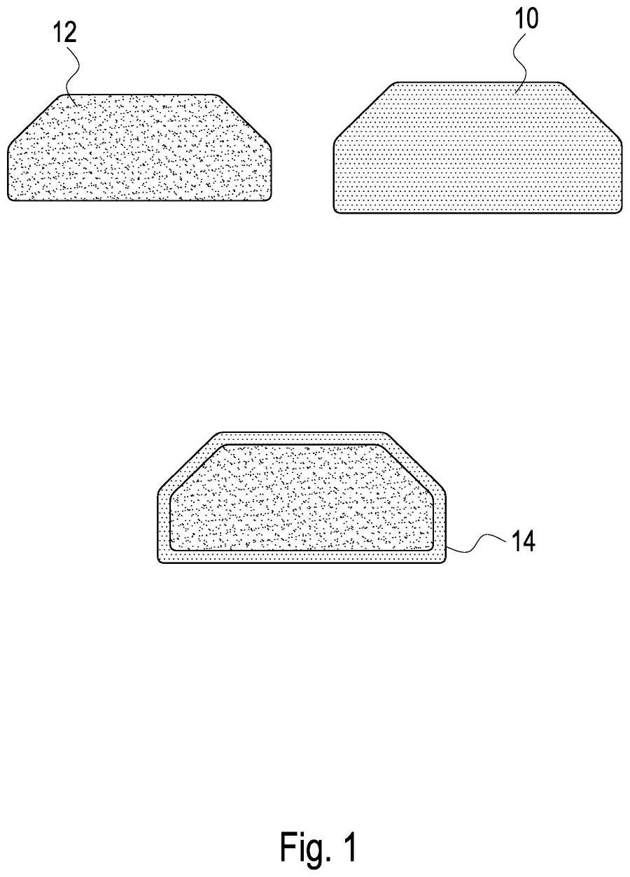

In an embodiment of the present disclosure (FIG. 1), a support layer 10 and/or a reinforcing layer 12 are produced from powdery material. In this regard, different approaches are possible. For example, the support layer 10 and the reinforcing layer 12 may be produced such that they already exist in their final form and are compacted or joined by the application of pressure and temperature. The joining of the support layer 10 with the reinforcing layer 12 may be effected by temperate and/or pressure. This is possible in particular if the two layers are made of the same or compatible powder materials.

As an alternative, the support layer 10 made of powder can be finished and, thereafter, powder for the reinforcing layer 12 can be arranged on the inner side of the support layer 10. Subsequently, the powder of the reinforcing layer is compacted or compounded by the application of temperature and/or pressure.

It is particularly preferred not yet to compound or compact the powder of the support layer 10, but to first provide powder for the reinforcing layer 12 on parts of the support layer 10. Thereafter, the powder of the support layer 10 and of the reinforcing layer 12 are compounded or compacted together by the application of temperature and/or pressure.

In the embodiment illustrated in FIG. 1, the reinforcing layer 12 is arranged such on the support layer 10 which has larger that a circumferential edge region is formed thereby. In the embodiment illustrated in FIG. 1, the edge region 14 has a substantially constant width and surrounds the reinforcing layer completely.

In another alternative embodiment, the support layer 10 is made of a plate material. Here, the support layer 10 e.g., already has the final outer contour obtained e.g., by cutting or punching. The forming of the outer contour may also be the last production step, if so intended. Thereafter, the powdery material of the reinforcing layer 12 is deposited in parts. If so intended, the inner side can be coated with a bonding agent to ensure a reliable joining of the support layer 10 and the reinforcing layer 12. After the powder of the reinforcing layer 12 has been deposited on the inner side of the support layer 10, temperature and/or pressure are applied again to produce the reinforcing layer. In this regard, it is particularly preferred that the reinforcing layer 12 is joined directly with the support layer 10, so that no bonding agent has to be provided.

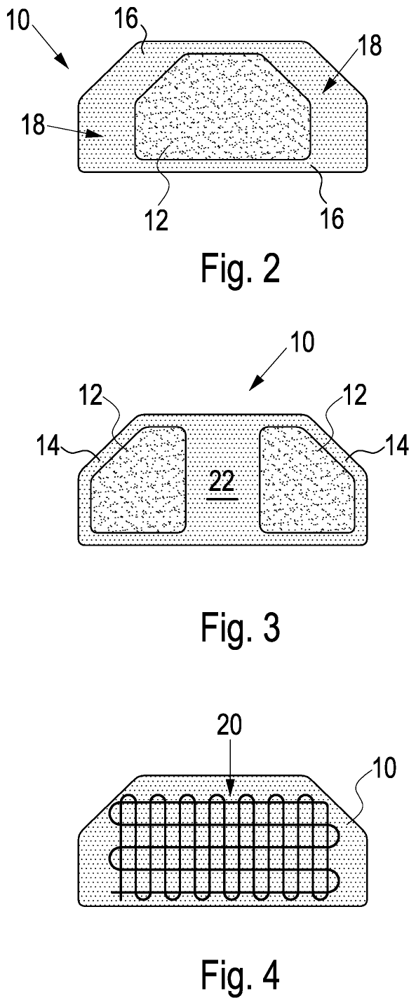

FIGS. 2 and 3 illustrate further alternative preferred embodiments of the reinforcing element of the disclosure, wherein similar and identical components are identified by the same reference numerals.

In FIG. 2, a reinforcing layer 12 is joined with the support layer 10, wherein, again, an edge region is provided that extends all around the circumference of the reinforcing layer 12. Here, the edge portion has a relatively narrow edge portion 16 at the upper and the lower side and two wider edge regions 18 at the sides. In this case, the edge regions 18 can e.g., form the lateral regions of a heel cap so that a good and reliable connection with the shoe material is ensured.

In FIG. 2, two reinforcing layers 12 are arranged on the support layer 10. These are arranged at a distance from each other so that in an intermediate region 18 only one layer of the support layer 10 is provided. At the sides, the two reinforcing layers 12 are each again surrounded by an edge region 14.

Possibly, the support layer 10 and/or the reinforcing layer 12 can also be produced using a 3D printing method, in particular a FDM method or a SLS method, with combinations of the different methods being possible as well.

As shown in the embodiment illustrated in FIG. 4, it is also possible to form a gridshaped reinforcing layer 20 on the support layer 10. The former may be produced separately or, in particular, be provided directly on the upper side of the support layer 12 using a 3D printing method.

What is claimed is:

1. Reinforcing element, in particular for shoes, bags or orthopedic applications, comprising
a support layer, and
a reinforcing layer surface-connected with the support layer,
wherein the support layer protrudes at least in parts laterally beyond the reinforcing layer to form an edge region.

2. Reinforcing element of claim 1, wherein the edge region surrounds the reinforcing layer completely.

3. Reinforcing element of claim 1, wherein the edge region has a substantially constant width.

4. Reinforcing element of claim 1, wherein the support layer and/or the reinforcing layer are produced from a prefabricated material.

5. Reinforcing element of claim 1, wherein the support layer and/or the reinforcing layer are made from a powdery material.

6. Reinforcing element of claim 1, wherein the support layer and the reinforcing layer are made from different materials.

7. Reinforcing element of claim 1, wherein an outer contour of the support layer and/or the reinforcing layer is obtained by punching and/or cutting.

8. Reinforcing element of claim 1, wherein an outer contour of the support layer and/or the reinforcing layer is obtained directly during manufacture.

9. Reinforcing element of claim 1, wherein an adhesive layer is provided on an outer side of the support layer and/or the reinforcing layer.

10. Reinforcing element of claim 1, wherein the reinforcing layer is produced in a 3D printing method.

11. Method for producing a reinforcing element in which
a reinforcing layer is connected with a support layer, and
an edge region is formed so that the support layer protrudes at least in part laterally beyond the reinforcing layer.

12. Method for producing a reinforcing element of claim 11, in which the edge region surrounds the reinforcing layer completely.

13. Method for producing a reinforcing element of claim 11, in which the edge region has a substantially constant width.

14. Method for producing a reinforcing element of claim 11, in which the support layer and/or the reinforcing layer are made of prefabricated plate material or rolled material.

15. Method for producing a reinforcing element of claim 11, in which the support layer and/or the reinforcing layer are made from a powdery material.

16. Method for producing a reinforcing element of claim 15, in which powder particles are arranged in one layer at least substantially in the final shape of an outer contour of the support layer and/or the reinforcing layer.

17. Method for producing a reinforcing element of claim 16, in which a layer of powder particles for forming the reinforcing layer is arranged on the support layer formed by powder particles.

18. Method for producing a reinforcing element of claim 17, in which the powder particles are compounded in particular by applying heat and/or pressure.

19. Method for producing a reinforcing element of claim 11, in which the support layer and/or the reinforcing layer are produced separately and the support layer is connected with the reinforcing layer.

20. Method for producing a reinforcing element of claim 1, in which the support layer and the reinforcing layer are produced together.

21. Method for producing a reinforcing element of claim 11, in which the reinforcing layer is arranged on the support layer by depositing a layer of powder particles.

22. Method for producing a reinforcing element of claim 11, in which the support layer and the reinforcing layer are made from different materials.

23. Method for producing a reinforcing element of claim 11 in which the reinforcing layer is produced preferably directly on the support layer using a 3D printing method.
